(19) United States
(12) Patent Application Publication
(10) Pub. No.: US 2009/0187516 A1
(43) Pub. Date: Jul. 23, 2009

(54) SEARCH SUMMARY RESULT EVALUATION MODEL METHODS AND SYSTEMS

(76) Inventors: Tapas Kanungo, San Jose, CA (US); David M. Orr, Mountain View, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 12/016,510

(22) Filed: Jan. 18, 2008

(51) Int. Cl. G06F 15/18

(52) U.S. Cl. 706/12

(57) ABSTRACT

Methods and systems are provided herein for establishing and/or using an evaluation model that is adapted to determine a model judgment value based, at least in part, on measured summary feature values associated with a search result summary. The evaluation model may be established through a learning process based, at least in part, on human judgment values associated with a set of search result summaries.

### BACKGROUND

1. Field

The subject matter disclosed herein relates to data processing, and more particularly to information extraction and information retrieval methods and systems.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating an exemplary computing environment including an information integration system having a search result summary evaluator.

FIG. 2 is a flow diagram illustrating an exemplary method that may, for example, be implemented at least in part using the information integration system of FIG. 1.

FIG. 3 is an illustrative diagram showing portions of a search result display that may be associated with the information integration system of FIG. 1.

FIG. 4 is a block diagram illustrating an exemplary embodiment of a computing environment system that may be operatively associated with computing environment of FIG. 1.

### DETAILED DESCRIPTION

Some exemplary methods and systems are described herein that may be used to establish and/or use an evaluation model that may be adapted to determine a model judgment value based, at least in part, on one or more measured summary feature values associated with a search result summary. The evaluation model may be established through a learning process based, at least in part, on human judgment values associated with a set of search result summaries. Such methods and systems may, for example, allow for relevant search related information to be identified and/or presented in an efficient manner.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web”. The web may be considered an Internet service organizing information through the use of hypermedia. Here, for example, the HyperText Markup Language (HTML) may be used to specify the contents and format of a hypermedia document (e.g., a web page).

Unless specifically stated, an electronic or web document may refer to either the source code for a particular web page or the web page itself. Each web page may contain embedded references to images, audio, video, other web documents, etc. One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocol.

Through the use of the web, individuals may have access to millions of pages of information. However, because there is so little organization to the web, at times it may be extremely difficult for users to locate the particular pages that contain the information that may be of interest to them. To address this problem, a mechanism known as a “search engine” may be employed to index a large number of web pages and provide an interface that may be used to search the indexed information, for example, by entering certain words or phases to be queried.

A search engine may, for example, include or otherwise employ on a “crawler” (also referred to as “crawler”, “spider”, “robot”) that may “crawl” the Internet in some manner to locate web documents. Upon locating a web document, the crawler may store the document's URL, and possibly follow any hyperlinks associated with the web document to locate other web documents.

A search engine may, for example, include information extraction and/or indexing mechanisms adapted to extract and/or otherwise index certain information about the web documents that were located by the crawler. Such index information may, for example, be generated based on the contents of an HTML file associated with a web document. An indexing mechanism may store index information in a database.

A search engine may provide a search tool that allows users to search the database. The search tool may include a user interface to allow users to input or otherwise specify search terms (e.g., keywords or other like criteria) and receive and view search results. A search engine may present the search results in a particular order, for example, as may be indicated by a ranking scheme. For example, the search engine may present an ordered listing of search result summaries in a search results display. Each search result summary may, for example, include information about a website or web page such as a title, an abstract, a link, and possibly one or more other related objects such as an icon or image, audio or video information, computer instructions, or the like.

While some or all of the information in certain search result summaries may be pre-defined or pre-written, for example, by a person associated with the website, the search engine service, and/or a third person or party, there may still be a need to generate some or all of the information in at least a portion of the search result summaries. Thus, when a search result summary does need to be generated, a search engine may be adapted to create a search result summary, for example, by extracting certain information from a web page.

With so many websites and web pages being available, it may be beneficial to identify which search result summaries may be more relevant, which search result summary features may be more or less important, and/or which search result summaries may be more or less informative. Unfortunately, collecting user (e.g., human) judgments regarding such search results and search result summaries tend to be laborious, time-consuming, and/or expensive.

With this is mind, methods and systems are provided for automated techniques that may approximate such human (e.g., user) judgment or otherwise act as a substitute therefore. The automated techniques may be scaleable, fast, and/or inexpensive to implement and/or operate. The automated techniques may provide quantitative metrics that reflect a perceived quality of search result summaries.

In accordance with one aspect of such automated techniques, an evaluation model may be provided and possibly trained to evaluate a search result summary and generate an objective model judgment value that may predict or otherwise may resemble a user judgment value (e.g., a quantitative quality score) for a given search result summary. Such model judgment values may be useful in ranking search result summaries. Such model judgment values may be useful in generating or otherwise preparing search result summaries. Such model judgment values may be useful to a search engine, web crawler, or the like. Such model judgment values may be useful to those involved in designing and developing websites and web pages.

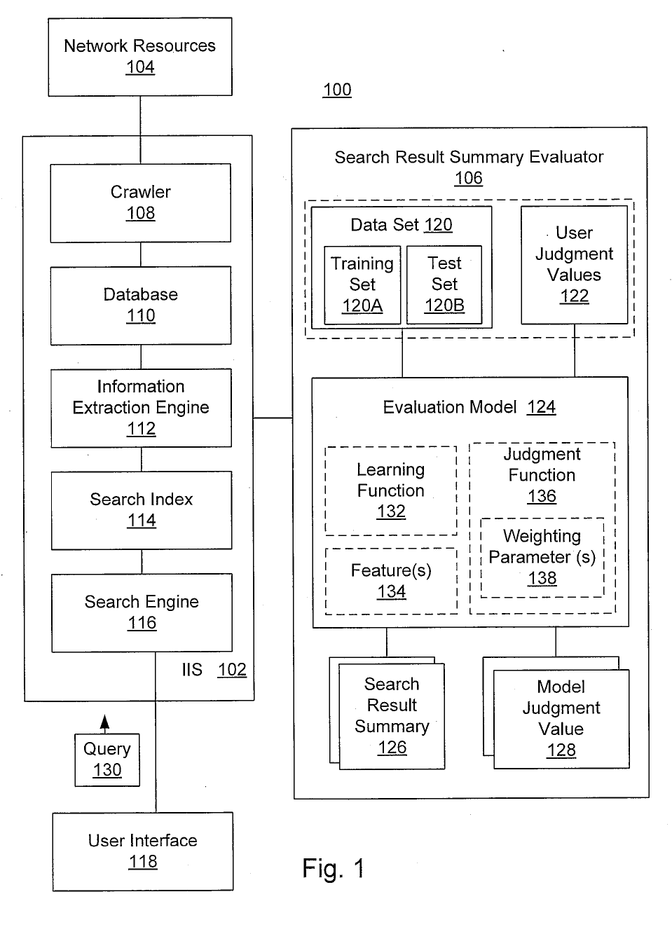

Attention is now drawn to FIG. 1, which is a block diagram illustrating an exemplary computing environment 100 having an Information Integration System (IIS) 102. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

IIS 102 may include a crawler 108 that may be opertively coupled to network resources 104, which may include, for example, the Internet and the World Wide Web (WWW), one or more servers, etc. IIS 102 may include a database 110, an information extraction engine 112, a search engine 116 backed, for example, by a search index 114 and possibly associated with a user interface 118 through which a query 130 may initiated.

Crawler 108 may be adapted to locate documents such as, for example, web pages. Crawler 108 may also follow one or more hyperlinks associated with the page to locate other web pages. Upon locating a web page, crawler 108 may, for example, store the web page's URL and/or other information in database 110. Crawler 108 may, for example, store an entire web page (e.g., HTML, XML, or other like code) and URL in database 110.

Search engine 116 generally refers to a mechanism that may be used to index and/or otherwise search a large number of web pages, and which may be used in conjunction with a user interface 118, for example, to retrieve and present information associated with search index 114. The information associated with search index 114 may, for example, be generated by information extraction engine 112 based on extracted content of an HTML file associated with a respective web page. Information extraction engine 112 may be adapted to extract or otherwise identify specific type(s) of information and/or content in web pages, such as, for example, job titles, job locations, experience required, etc. This extracted information may be used to index web page(s) in the search index 114. One or more search indexes 126 associated with search engine 116 may include a list of information accompanied with the network resource associated with information, such as, for example, a network address and/or a link to, the web page and/or device that contains the information. In certain implementations, at least a portion of search index 116 may be included in database 110.

IIS 102 may also include a search result summary evaluator 106. As shown search result summary evaluator 106 may be opertively coupled to IIS 102.

Search result summary evaluator 106 may, for example, include an evaluation model 124 that accesses at least one search result summary 126 that may be generated by IIS 102 and generates a corresponding model judgment value 128. In this example, search result summary evaluator 106 may also be “trained” based on a data set 120 (e.g., plurality of search result summaries) and corresponding user judgment values 122. As shown here, the data set 120 may include, for example, a training set 120A and a test set 120B.

Also, as illustrated by the dashed line box surrounding data set 120 and user judgment values 122, in certain implementations such data may be combined to form a data set having a set of triples (e.g., queries, summaries, and user judgments), which may be split into a training subset and a test subset.

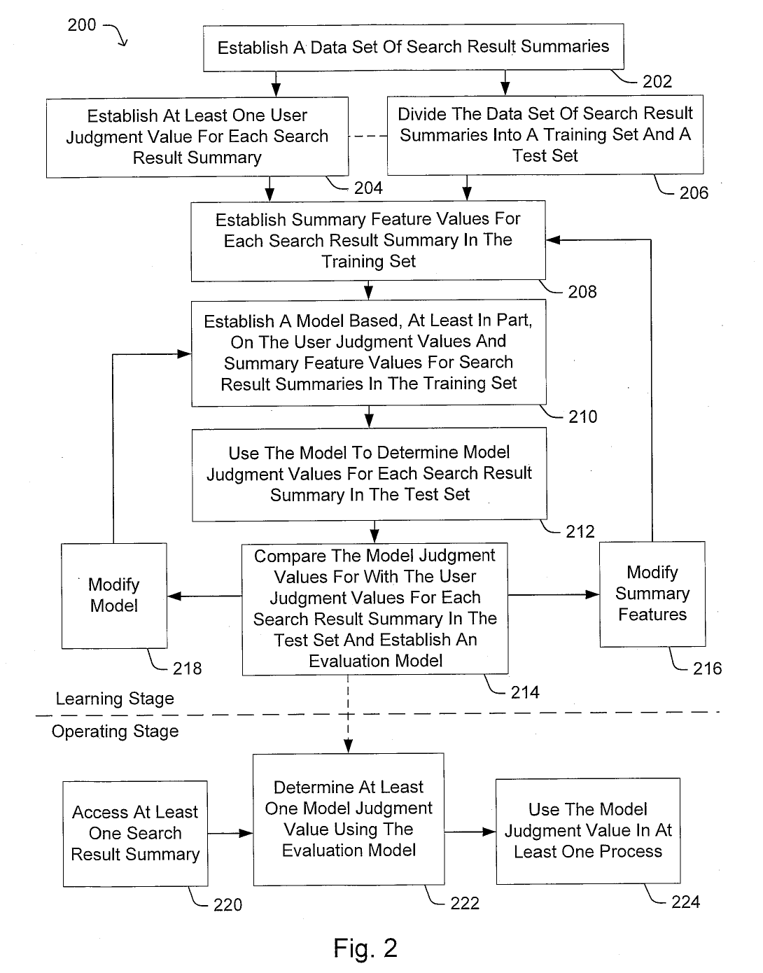

All or portions of exemplary method 200 as shown in FIG. 2 may be implemented in search result summary evaluator 106. As shown, method 200 may include a learning stage wherein search result summary evaluator 106 may be trained and an operating stage wherein search result summary evaluator 106 may be operated.

As part of the learning stage, at block 202, a data set of search result summaries may be established. For example, one or more queries may be provided to a search engine to generate a set of search result summaries. Such quires may or may not be related. At block 204, at least one user judgment value may be established for each search result summary. Here, for example, users may be presented with one or more search result summaries and asked to evaluate and score each search result summary with regard to some criteria (e.g., relevance to a search query or topic, or informative nature, etc.). Such user judgment values may be more subjective and/or objective. Such user judgment values may represent an average of user judgment values from a plurality of users.

At block 206, the data set may, for example, be divided into a training set and a test set. For example, the data set may be divided into equal portions.

Blocks 204 and 206 may be associated with separate processes, or as illustrated by the dashed line connecting blocks 204 and 206 may be combined in some manner. For example, in certain implementations it may be useful to collect a set of triples (e.g., queries, summaries, and user judgments) and then split this set of triples into a training subset and a test subset.

It should be understood also, that two or more of the blocks in exemplary method 200 may be combined in certain implementations, and/or one of the blocks in exemplary method 200 may be further divided or otherwise distributed among a plurality of processes.

At block 208, one more summary feature values may be determined for each search result summary in the training set. The summary feature value may be associated with one or more identified summary features, which may or may not be present in a given search result summary. Such summary features may correspond to features that are at least perceived to be either more or less important to users, may be indicative of apparent user preferences with regard to search result summaries, may correspond in some manner to the quality or perceived quality of a search, and/or may be of some beneficial use to web design, web crawling, searching, search indices, search result summaries, search result summary displays, search result summary generation, or the like. Such summary features may be measured at block 208 and considered in establishing an evaluation model at blocks 210 and/or 214.

By way of example but not limitation, exemplary summary features may include at least one feature that relates to the presence, style, location, and/or order of terms or portions thereof as presented within a search query, and/or the presence, style, location, and/or order of certain object(s) (e.g., non-text) that may be included in a search result summary. Such exemplary features may be measured within all or selected portion(s) of the search result summary.

For example, in a title portion of a search result summary the presence, style, location and/or order of search terms or portions thereof may be measured. In an exemplary implementation such measurable title features may include the number of query terms in the title, their style (e.g., bolded, highlighted, or otherwise visibly different text), and/or the location within the title (e.g., with regard to the left hand side of the title). For example, for text nearer to the beginning of a title may be more likely to be seen by a user quickly scanning a search result summary; as such, terms at or near the beginning of the title may be more topical or otherwise perceived as being more relevant than terms appearing nearer the end of the title. Hence, the presence, style, and/or location of such terms or portions thereof within the title may be measured at block 208 and considered in establishing an evaluation model at blocks 210 and/or 214.

Further, the location or proximity of two or more query terms or portions thereof with regard to one another (e.g., closeness or separation) in the title may be measured, as may the ordering of such terms in the title. For example, a search result summary may be perceived by a user to be more relevant if the terms in the title are more proximate in their respective location and/or the more correctly ordered with respect to their order in the original query. If there is a “perfect” or substantial match of the original query terms (e.g., to the left, in the correct order, etc.) in the title, then measuring such may help to determine how relevant the search result summary may be perceived by a user.

An abstract portion of a search result summary may, for example, be considered and the presence, style, location, and/or order of search terms or portions thereof may be measured. In an exemplary implementation the same or similar features as measured in the title may be measured in the abstract. For example, the presence (e.g., number) of query terms in the abstract may be measured, the location (e.g., line number, closeness to the beginning of the abstract or a portion thereof), the first, number, and/or style (e.g., a percentage bolded, highlighted, or otherwise visibly different text), the location, arrangement, and/or proximity of the query terms with respect to one another, the order of query terms, the percentage of the unique query terms included (or absent) in the abstract, and/or a “perfect” or substantial match of terms in the abstract may be measured at block 208 and considered in establishing an evaluation model at blocks 210 and/or 214.

Similarly, in a link portion (e.g., having a URL. network address, or other like link) of a search result summary the presence, style, location, and/or order of search terms may be measured. In an exemplary implementation the same or similar features as measured in the title and/or abstract may be measured in the abstract. For example, in a URL link a number of query terms in the URL may be measured. For example, in a URL link a URL depth (e.g., closeness/distance a web page is to the top of a web site) may be measured or approximated by number of /'s in the URL.

All or part of the exemplary features described herein may be combined or otherwise measured for the search result summary in its entirety. For example, a percentage of the query terms or portions thereof anywhere within a search result summary may be measured.

While the example above refer to query terms or portions thereof, the same or similar measurements may be made for objects that might be included or otherwise identified in the search result summary. For example, the presence (or absence), style (e.g., type, size, length, etc.), and/or location of an object may be measured at block 208 and considered in establishing an evaluation model at blocks 210 and/or 214. For example, the presence or absence, type, size, related metadata, and/or location of an image object (e.g., icon or other like graphic element, JPEG image, GIF, etc.) within a search result summary may be measured at block 208 and considered in establishing an evaluation model at blocks 210 and/or 214. For example, the presence or absence, type, size (e.g., bytes), length (e.g., temporal), related metadata, and/or location of a audio or video object (e.g., MP3, MPEG, or other like object/file) within a search result summary may be measured at block 208 and considered in establishing an evaluation model at blocks 210 and/or 214.

At block 210, a model may be established based, at least in part, on the user judgment values of block 204 and at least one of the summary feature values of block 208 for search result summaries in the training set. Block 210 may, for example, include estimating or otherwise establishing model parameters using a modeling/regression method implemented in a machine learning based algorithm or other like process. By way of example but not limitation, such model may apply surface-fitting, curve-fitting, and/or other like statistical modeling techniques, as are well known. An example of such modeling techniques may be found in. the TreeNet® application available from Salford Systems of San Diego, Calif. Those skilled in the art will recognize that other types of modeling techniques or applications (e.g., neural networks, etc.) may be used or otherwise adapted for use in establishing a model at block 210 (and at block 214).

At block 210, for example, the measured summary features of search result summaries that are believed to be indicative of or otherwise associated with a search result that users may perceive or otherwise deem to be more or less relevant, useful, etc., may be considered to determine which features appear to be more or less important by running a machine learning algorithm using the measured values and training or otherwise developing an evaluation model using such summary features to possibly predict or otherwise estimate the user judgment values for other search result summaries. Such an evaluation model may, for example, be used to determine search result summary quality which may help to improve a search engine.

In accordance with certain aspects, as the evaluation model is established at blocks 210 and 214 the importance or lack thereof for certain summary features may be determined based on the learning process that considers the user judgment values and the measured summary features. In certain instances, for example, the user judgment values may be very subjective and differ from one user to another and from one web site to another and what if any summary features may have increased or decreased the user judgment values may be unknown or otherwise not made clear during the user's review of the search result summaries. However, given an adequate number of user judgment values and measured summary features it may be possible to identify or otherwise predict in some manner by using such modeling techniques the relative importance of such summary features as might occur in search result summaries. Moreover, as described herein, once an evaluation model has been established, it may continue to learn and may be used to quickly determine model judgment values for other search result summaries. Additionally, the summary features that are measured may be modified or otherwise adapted over time to further increase the effectiveness and/or efficiency of the evaluation model.

Continuing with the learning process of method 200, at block 212, the model established at block 210 may be used to determine model judgment values for each of the search result summaries in the test set. At block 214, the model judgment values of block 212 may be compared to the user judgment values of block 204 for each of the search result summaries in the test set. If the model judgment values are similar enough (e.g., within an acceptable margin or desired threshold) when compared to the user judgment values for the search result summaries in the test set, then the evaluation model may be established and ready for operation.

If the model judgment values are not similar enough (e.g., within outside of an acceptable margin or below a desired threshold) when compared to the user judgment values for the search result summaries in the test set, then at block 216 the summary features may be modified (e.g., changed, added, deleted) and method 200 may continue at block 208 and the learning process repeated, as needed, until an acceptable evaluation model is established at block 214.

If the model judgment values are not similar enough (e.g., within outside of an acceptable margin or below a desired threshold) when compared to the user judgment values for the search result summaries in the test set, then at block 218 the model parameters or other like capabilities may be modified (e.g., changed, added, deleted) and method 200 may continue at block 210 and the learning process repeated, as needed until an acceptable evaluation model is established at block 214.

Once an acceptable evaluation model is established at block 214, as shown in exemplary method 200, an operating stage may begin wherein at block 220 at least one search result summary may be accessed and at block 222 at least one model judgment value may be determined using the evaluation model. The method may also include, at block 224, using the model judgment value of block 222 in at least one process, for example, as described herein that may find such model judgment values of use. Such an evaluation model may, for example, be applied to millions of search result summaries to essentially act as a real time correlated surrogate for actual human judgment values.

In certain exemplary implementations, evaluator 106 and/or method 200 may provide a machine-learned TAU (title, abstract, URL) Quality Metric (TQM) evaluation model wherein a database of search result summaries may be created for corresponding queries with tuples <q, S>. User judgment values J regarding the quality of the summaries on a quantitative scale (e.g., 1-5, worst to best) may be collected or otherwise accessed and divided into sets, such as a training set and a test set. Summary features values f_i , i=1, . . . n, for each <q,S> may be measured or otherwise established to create a database with records <id, f_{—}1, . . . , f_n, j>. Model parameters may be estimated using a modeling/regression method, and used to determine model judgment values that estimate or otherwise predict user judgments j′ on unseen data (e.g., the test set). A contingency table of (j,j′) may be created to determine how well the model judgments match the user judgments and various statistical measures (e.g., errors) that reflect on the correlation of true and predicted judgments may be identified to help modify the evaluation model and/or summary features until the correlation is within acceptable limits. The resulting established evaluation model may, for example, be used for relevance and/or quality prediction as a surrogate for user judgments.

In certain situations, the techniques provided herein may advantageously leverage (e.g., by data mining) large user judgment data sets that may have been collected for other reasons, such as to adjust a ranking algorithm. The techniques provided herein may help to identify summary features that may be more important to users but which such users may not be consciously aware of or otherwise able to recognize or otherwise communicate effectively.

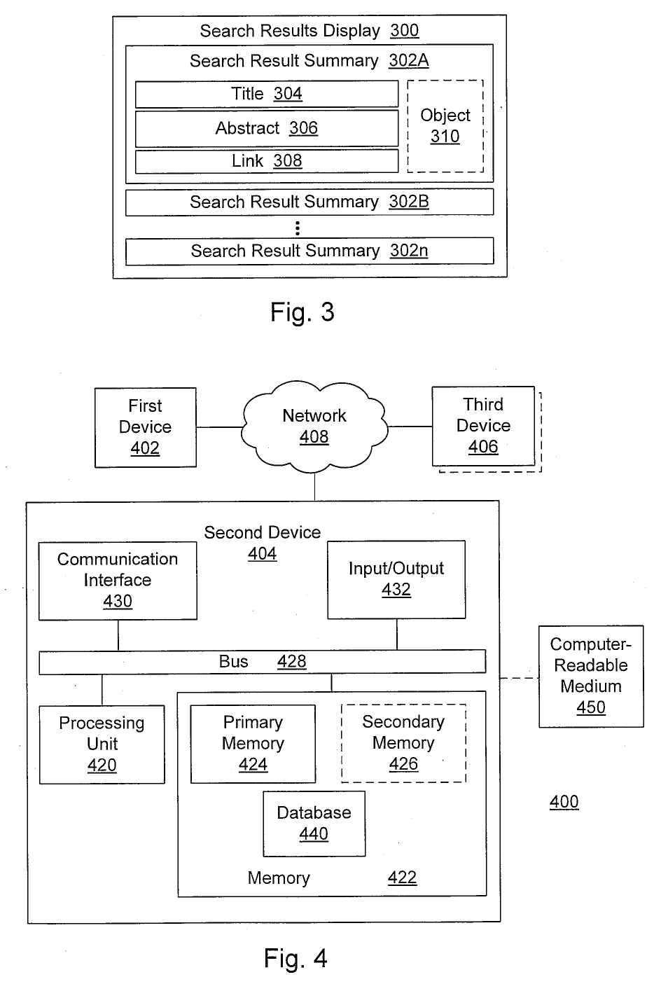

FIG. 3 is an illustrative diagram showing an exemplary search results display 300, for example, as might be shown to a user through a user interface and input/output device. Search results summary display 300 may include a plurality of search result summaries 302 associated with a query. Here, for example, search result summary 302A, 302B, through 302n are shown. Exemplary search result summary 302A may include one or more portions such as, for example, a title 304, an abstract 306, a link 308, and/or an object 310.

FIG. 4 is a block diagram illustrating an exemplary embodiment of a computing environment system 400 which may be operatively associated with computing environment 100 of FIG. 1, for example,.

Computing environment system 400 may include, for example, a first device 402, a second device 404 and a third device 406, which may be operatively coupled together through a network 408.

First device 402, second device 404 and third device 406, as shown in FIG. 4, are each representative of any device, appliance or machine that may be configurable to exchange data over network 408 and host or otherwise provide one or more replicated databases. By way of example but not limitation, any of first device 402, second device 404, or third device 406 may include: one or more computing devices or platforms, such as, e.g., a desktop computer, a laptop computer, a workstation, a server device, storage units, or the like.

Network 408, as shown in FIG. 4, is representative of one or more communication links, processes, and/or resources configurable to support the exchange of data between at least two of first device 402, second device 404 and third device 406. By way of example but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 406, there may be additional like devices operatively coupled to network 408.

It is recognized that all or part of the various devices and networks shown in system 400, and the processes and methods as further described herein, may be implemented using or otherwise include hardware, firmware, software, or any combination thereof.

Thus, by way of example but not limitation, second device 404 may include at least one processing unit 420 that is operatively coupled to a memory 422 through a bus 428.

Processing unit 420 is representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 450. Computer-readable medium 450 may include, for example, any medium that can carry and/or make accessible data, code and/or instructions for one or more of the devices in system 400.

Additionally, as illustrated in FIG. 4, memory 422 may include a data associated with a database 440. Such data may, for example, be stored in primary memory 424 and/or secondary memory 426.

Second device 404 may include, for example, a communication interface 430 that provides for or otherwise supports the operative coupling of second device 404 to at least network 408. By way of example but not limitation, communication interface 430 may include a network interface device or card, a modem, a router, a switch, a transceiver, and the like.

Second device 404 may include, for example, an input/output 432. Input/output 432 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 432 may include an operatively adapted display, speaker, keyboard, mouse, trackball, touch screen, data port, etc.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
accessing a plurality of search result summaries and a corresponding plurality of user judgment values associated with said plurality of search result summaries;
for each search result summary, determining at least one summary feature value; and
establishing an evaluation model adapted to determine a model judgment value based, at least in part, on said determined summary feature values, said evaluation model being trained through a learning process using said plurality of search result summaries and said plurality of user judgment values.

2. The method as recited in claim 1, wherein, for at least one of said search result summaries, determining said at least one summary feature value comprises measuring at least one feature of said search result summary selected from a group of features comprising a presence feature, a style feature, a location feature, and an order feature.

3. The method as recited in claim 1, wherein, for at least one of said search result summaries, determining said at least one summary feature value comprises determining said at least one summary feature value based, at least in part, on at least a portion of said at least one search term.

4. The method as recited in claim 1, wherein at least one search result summary comprises at least one type of information portion selected from a group distinguishable information portions comprising a title, an abstract, a link, and an object.

5. The method as recited in claim 1, wherein at least one of said plurality of user judgment values comprises an average of user judgment values from a plurality of users.

6. A method comprising:
accessing at least one search result summary; and
using a search result summary evaluation model determine a model judgment value for said search result summary based, at least in part, on at least one measured summary feature value, wherein said search result summary evaluation model has been trained through a learning process using a plurality of search result summaries and a corresponding plurality of user judgment values associated with said plurality of search result summaries.

7. The method as recited in claim 6, wherein said at least one measured summary feature value is associated with at least one feature of said search result summary selected from a group of features comprising a presence feature, a style feature, a location feature, and an order feature.

8. The method as recited in claim 6, wherein said at least one summary feature value is based, at least in part, on at least a portion of at least one search term associated with said search result summary.

9. The method as recited in claim 6, wherein at least one search result summary comprises at least one type of information portion selected from a group distinguishable information portions comprising a title, an abstract, a link, and an object.

10. A system comprising:
memory adapted to store a plurality of search result summaries; and
at least one processing unit operatively coupled to said memory and adapted to access said plurality of search result summaries and a corresponding plurality of user judgment values associated with said plurality of search result summaries, determine at least one summary feature value for each search result summary, and establish an evaluation model adapted to determine a model judgment value based, at least in part, on said determined summary feature values, said evaluation model being trained through a learning process using said plurality of search result summaries and said plurality of user judgment values.

11. The system as recited in claim 10, wherein said at least one processing unit is adapted to, for at least one of said search result summaries, measure at least one feature of said search result summary selected from a group of features comprising a presence feature, a style feature, a location feature, and an order feature.

12. The system as recited in claim 10, wherein said at least one processing unit is adapted to, for at least one of said search result summaries, determine said at least one summary feature value based, at least in part, on at least a portion of said at least one search term.

13. The system as recited in claim 10, wherein at least one search result summary comprises at least one type of information portion selected from a group distinguishable information portions comprising a title, an abstract, a link, and an object.

14. The system as recited in claim 10, wherein at least one of said plurality of user judgment values comprises an average of user judgment values from a plurality of users.

15. A system comprising:
memory adapted to store at least one search result summaries; and
at least one processing unit operatively coupled to said memory and adapted accessing said search result summary, and with a search result summary evaluation model determine a model judgment value for said search result summary based, at least in part, on at least one measured summary feature value, wherein said search result summary evaluation model has been trained through a learning process using a plurality of search result summaries and a corresponding plurality of user judgment values associated with said plurality of search result summaries.

16. The system as recited in claim 15, wherein said at least one measured summary feature value is associated with at least one feature of said search result summary selected from a group of features comprising a presence feature, a style feature, a location feature, and an order feature.

17. The system as recited in claim 15, wherein said at least one summary feature value is based, at least in part, on at least a portion of at least one search term associated with said search result summary.

18. The system as recited in claim 15, wherein at least one search result summary comprises at least one type of information portion selected from a group distinguishable information portions comprising a title, an abstract, a link, and an object.

19. A computer program product, comprising computer-readable medium comprising instructions for causing at least one processing unit to:
access a plurality of search result summaries and a corresponding plurality of user judgment values associated with said plurality of search result summaries;
determine at least one summary feature value for each search result summary; and
establish an evaluation model adapted to determine a model judgment value based, at least in part, on said determined summary feature values, said evaluation model being trained through a learning process using said plurality of search result summaries and said plurality of user judgment values.

20. A computer program product, comprising computer-readable medium comprising instructions for causing at least one processing unit to:
access at least one search result summary; and
apply an established search result summary evaluation model to measure at least one summary feature value of said at least one search result summary and determine a model judgment value for said search result summary based, at least in part, on said measured summary feature value, wherein said search result summary evaluation model has been trained through a learning process using a plurality of search result summaries and a corresponding plurality of user judgment values associated with said plurality of search result summaries.
